(19) United States
(12) Patent Application Publication
(10) Pub. No.: US 2019/0357312 A1
(43) Pub. Date: Nov. 21, 2019

(54) STRUCTURAL COMPONENT FOR AN AIRCRAFT

(71) Applicants: Airbus Operations GmbH, Hamburg (DE); Airbus Defence and Space GmbH, Ottobrunn (DE)

(72) Inventors: Peter LINDE, Hamburg (DE); Christian KARCH, Neubiberg (DE); Elmar BONACCURSO, Höhenkirchen (DE)

(21) Appl. No.: 16/388,322

(22) Filed: Apr. 18, 2019

(30) Foreign Application Priority Data
May 16, 2018 (DE) 102018111703.5

(51) Int. Cl. H05B 3/14; B64D 15/12; B64F 5/10; B64C 3/26; B64C 5/02; H05B 3/06; H05B 3/16; B32B 27/12; B32B 27/20; B32B 9/00

(52) U.S. Cl. CPC H05B 3/145; B64D 15/12; B64F 5/10; B64C 3/26; B64C 5/02; B32B 2605/18; H05B 3/16; B32B 27/12; B32B 27/20; B32B 9/005; B32B 2262/101; H05B 3/06

(57) ABSTRACT

A structural component for an aircraft includes at least one heatable component portion. The heatable component portion has a layered construction with an inner base structure, a first insulating layer arranged outside the inner base structure, a functional layer of carbon allotropes embedded in a matrix material, which is arranged outside the first insulating layer, and at least one protective layer arranged outside the functional layer. The structural component also includes an electrical connection device connected to the functional layer for selectively applying an electrical current to the functional layer to heat the functional layer.

### CROSS-REFERENCE TO PRIORITY APPLICATION

This application claims the benefit of, and priority to, German patent application number DE 102018111703.5, filed May 16, 2018. The content of the referenced application is incorporated by reference herein.

### TECHNICAL FIELD

Embodiments of the subject matter described herein relate generally to a structural component for an aircraft, a method for manufacturing a structural component, and an aircraft having at least one such structural component.

### BACKGROUND

In certain ambient conditions and flying states, components of aircraft which face directly into an oncoming flow can be subject to icing. Numerous devices which can, however, achieve an ice-free state of these components are known from the prior art. On the one hand, devices are known which prevent the initial adherence of ice (so-called anti-icing). Furthermore, devices are known which can remove already-adhered ice (so-called deicing). The devices can be based on the introduction of heat, for instance via bleed air which is taken from compressor stages of a turbojet engine. Moreover, devices are known in which ice is dislodged by actively deforming front edge regions, for instance via pneumatically expandable elastomer pads, via transient magnetic forces in the case of metal front edges or the like.

In modern commercial aircraft, the use of bleed air is limited and a total departure from bleed air is preferred. Therefore, devices also exist which can generate heat in a different way. It is known, for instance, to arrange heater mats with electrical resistance heating on an inner side of front edges of flow components to generate and emit heat locally.

Patent publication EP 2 873 617 A1 discloses a device for deicing and/or preventing ice formation for an aircraft which comprises a heat-emitting device for emitting heat to a surface region of the aircraft, which heat-emitting device is designed for linear heat emission in order to generate a predetermined breaking point or predetermined breaking line or separating line in ice accumulating on the surface region.

### BRIEF SUMMARY

It is an object of the disclosure to propose a structural component which is disposed in an alternative and improved manner for local heating and has as low a weight as possible.

The object is achieved by a structural component having the features of the independent claim 1. Advantageous embodiments and further developments are revealed in the subclaims and the description below.

A structural component for an aircraft is proposed, which comprises at least one heatable component portion. The heatable component portion further comprises a layered construction having an inner base structure, a first insulating layer arranged outside the inner base structure, a functional layer of carbon allotropes embedded in a matrix material, which functional layer is arranged outside the first insulating layer, and at least one protective layer arranged outside the functional layer. The structural component further comprises an electrical connection device connected to the functional layer for selectively applying an electrical current to the functional layer for heating the functional layer.

According to the disclosure, the structural component consequently possesses a construction which includes a plurality of layers. At this point, it should already be pointed out that this layered construction does not necessarily have to be a composite material of fiber-reinforced plastics, but can also comprise metal layers. Further layers, which likewise have a function but are not mentioned explicitly, can furthermore also be arranged between the individual layers.

The inner base structure is provided for achieving a desired stability of the component. In particular, the inner base structure is designed so that the required mechanical strength is provided practically exclusively by the inner base structure. Depending on the concept of the aircraft, the inner base structure can include one or more different materials. In addition to classic metal structures, fiber-composite materials or combinations thereof are also conceivable. In addition to a shell-shaped component, the inner base structure can also contain a stiffening structure.

A first insulating layer is arranged outside the inner base structure. The first insulating layer can be arranged directly on the inner base structure or on one or more intermediate layers. The first insulating layer can be, in particular, an electrically insulating layer, although it can also serve for thermal insulation. These variants are explained further below.

A functional layer of carbon allotropes embedded in a matrix material is arranged outside the first insulating layer. Through the use of such a construction, an electrically conductive, thin layer can be realized, which enables the introduction of heat over a large surface by applying an electrical voltage. The functional layer can have a particularly small thickness, which minimizes additional weight for the structural component. Nevertheless, the use of carbon allotropes results in particularly advantageous heat development when an electrical voltage is applied to the functional layer. The functional layer can be constructed from an individual woven fabric layer. Alternatively to this, the functional layer can also contain a layer of unwoven, ordered or unordered allotropes which have a thickness which corresponds to the thickness of an individual woven fabric layer.

The protective layer, which is arranged outside the second insulating layer, serves mainly for protection against erosion and other mechanical disturbances of the layered construction. This can comprise a varnish, a paint, a metal protective layer or the like. Of course, the protective layer can also be a multi-layered construction.

A deicing device having a particularly low weight and yet a high efficiency is provided by the construction according to the disclosure. In addition, the use of carbon allotropes which are embedded in a matrix material at least partially enables the function of protecting the inner base structure against mechanical damage caused by external mechanical shocks. Depending on the strength of a bird strike, hail or other shock, for example, the mechanical disturbance of the inner base structure can be reduced or prevented.

A particular further advantage is that particularly good protection against shock-induced mechanical damage to the respective front edge is achieved. In particular, a combination of a thermoplastic matrix material with embedded carbon allotropes and preferably carbon nanotubes can achieve the desired shock protection. Whilst metal structures can, in principle, become damaged in the event of a mechanical shock load, a considerable reduction in mechanical damage—to the total prevention of mechanical damage—can be achieved depending on the number of layers of carbon allotropes. Even a single layer of a mat of unwoven carbon nanotubes, for example, could be sufficient to achieve a considerable reduction in possible damage.

In an advantageous embodiment, a second insulating layer can additionally be arranged outside the functional layer, which insulating layer can be constructed similarly to the first insulating layer. However, this second insulating layer should be configured such that, in particular, electrical insulation is realized. Nevertheless, particular value should be placed on enabling heat to be transferred outwards from the functional layer as freely as possible to maximize the efficiency with which heat is introduced.

In a preferred embodiment, the inner base structure comprises a composite structure of a matrix material with reinforcing fibers embedded therein. In particular, the matrix material can be a polymer or a resin system in which the reinforcing fibers are embedded. These could be realized in the form of woven fabrics or laid fiber fabrics, which are single-layered or preferably multi-layered and are provided according to the envisaged load direction. It is particularly possible to use reinforcing fibers which extend in multiple layers and in multiple directions. The fiber directions can be adapted to required mechanical properties. As an alternative to this, layers of unwoven fibers or laid fiber fabrics could also be used. In this case, the fibers could have one or more discrete fiber directions or be realized omnidirectionally to achieve quasi-isotropic properties. In addition, one or more layers of a metal material could be provided. In particular, in this embodiment of the inner base structure, the particular advantage of the construction is that all layers can be readily manufactured by means of a substantially conventional method for manufacturing a component from a fiber-composite material. All layers are flexible and can be applied to a tool surface in web form and in an automated manner. All layers comprising a matrix material can be hardened together and consequently form a monolithic component.

The inner base structure preferably comprises a carbon-fiber reinforced plastics material. The combination of a carbon-fiber reinforced plastics material with the functional layer can prevent galvanic corrosion between the base structure and the functional layer. In addition to the embodiment as a thermosetting plastic with carbon fibers, a thermoplastic with embedded carbon fibers can also be taken into consideration. This can include, in particular, polyetherketoneketone (PEKK), polyetheretherketone (PEEK), polyetherimide (PEI), polycarbonate (PC), polypropylene (PP) or other polymers.

The functional layer preferably comprises carbon nanotubes, which are embedded in the matrix material. The density of mats, laid fiber fabrics or woven fabrics of carbon nanotubes is very low. The density depends on the manufacturing process, the type of carbon nanotubes (single walled, double walled, multi-walled) and the chemical and thermal post-treatment. In general, the density can be approximately 0.2 to approximately 0.8 g/cm³. In direct comparison to the density of graphite (2.1 to 2.3 g/cm³) and the density of metal structures/wires (aluminum approximately 2.7 g/cm³), the weight saving when using carbon nanotubes is clearly recognizable. In spite of the considerably lower weights, losses in terms of the heat development are not to be expected. In addition to this, higher current densities can be realized compared to graphite- or metal-based heating elements. Moreover, the current-carrying capacity of a structure of carbon nanotubes is many times higher than that of aluminum or copper. Moreover, the thermal stability can be improved considerably when using carbon nanotubes. Heating elements comprising carbon nanotubes enable a particularly uniform temperature distribution to be achieved, which is hardly possible when using metal wires, graphite or other carbon allotropes. Owing to the low thermal mass, particularly rapid heating can be achieved.

If a matrix material in the form of a thermoplastic is used for the functional layer, this can have particular advantages for the shock absorption. A thermoplastic, in itself, can already have a shock-absorbing effect. In combination with carbon nanotubes, in particular, the capacity for absorbing shocks can be increased.

It is preferred that the functional layer is formed from a porous mat of unwoven carbon nanotubes. The mat is particularly suitable for being integrated into a conventional manufacturing process for a structural component of carbon-fiber reinforced plastics material, for instance. The individual carbon nanotubes adhere to one another as a result of the Van der Waals forces and have quasi isotropic properties. A particularly advantageous replacement for an otherwise metal, electrically conductive material is thus achieved.

In a preferred embodiment, the first insulating layer is designed as a thermal and electrical insulating layer. The first insulating layer can comprise non-conductive fibers, in particular glass fibers. Like carbon fibers, glass fibers, owing to their suitability for processing as flexible woven fabrics or laid fiber fabrics, can be processed very easily and adapted to desired mechanical properties. Since glass fibers are moreover non-conductive, it is possible to incorporate a first insulating layer based on glass fibers in the layered construction. The first insulating layer can consequently comprise a glass-fiber composite material, for instance, in which glass fiber layers in the form of laid fiber fabrics or woven fabrics are embedded in a matrix material. The matrix material of the first insulating layer does not necessarily have to correspond to the matrix material of other layers.

Alternatively, the first insulating layer can also comprise carbon fibers, which possess an insulating coating. The material continuity within the layered construction is improved and the stability compared to glass fibers is slightly increased. In particular, in the position of the first insulating layer, voltage jumps and delaminations can thus be better prevented.

The second insulating layer is preferably realized as an electrical insulating layer. Therefore, in particular, the current flow can be limited to the functional layer and is not applied to adjacent components. The construction of the second insulating layer can substantially correspond to that of the first insulating layer.

The second insulating layer can comprise, for instance, aluminum nitride, for example in the form of a thin polymorphous layer.

The disclosure further relates to a method for manufacturing a structural component, in particular a structural component according to one of claims 1 to 9, comprising the steps: providing an inner base structure, applying a first insulating layer to the inner base structure, applying a functional layer of carbon allotropes embedded in a matrix material and applying a protective layer.

The method can preferably comprise the hardening of at least the functional layer. This can be implemented as a final step or as a step before applying the protective layer.

The method can further include the step of applying a second insulating layer.

The method is preferably implemented so that at least the arrangement of the functional layer takes place with the aid of an automated device. This is preferably equipped with an automated fiber placement head or an automated tape placement head.

The disclosure further relates to an aircraft comprising at least one structural component according to the description above, wherein the aircraft comprises an electrical energy source, which is selectively connectable to the connection device.

In an advantageous embodiment, the heatable component portion is arranged on a front edge of the structural component.

In this case, the at least one structural component can be at least one component of a wing or a tail unit.

Finally, the disclosure relates to the use of a functional layer of carbon nanotubes embedded in a matrix material on a structural component of an aircraft for electrical heating and for protection against mechanical shocks of a front edge of the structural component.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Further features, advantageous and possible applications of the present disclosure are revealed in the description below of the exemplary embodiments and the figures. In this case, all described and/or depicted features form the subject matter of the disclosure in themselves and in any combination, also regardless of their composition in the individual claims or their dependencies. In the figures, the same reference signs furthermore represent the same or similar objects.

FIG. 1 shows a schematic, partially sectional, three-dimensional illustration of a structural component.

FIG. 2 shows a device for the automated manufacture of a structural component.

FIG. 3 shows an aircraft which comprises such a structural component.

FIG. 4 shows a schematic, block-based diagram of a method according to the disclosure for manufacturing a structural component.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

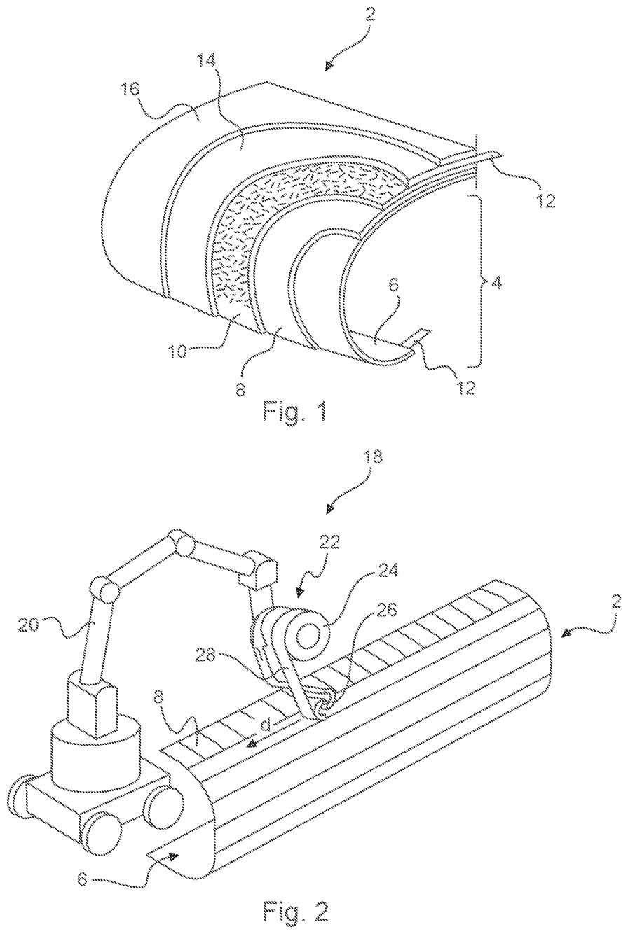

FIG. 1 shows part of a structural component 2, which comprises a heatable component portion 4. By way of example, the structural component 2 is part of a wing, wherein the heatable component portion 4 forms a front edge. The structural component 2 comprises an inner base structure 6, which can be realized in different ways. The inner base structure 6 is illustrated merely schematically here. It is, in fact, possible to provide an inner base structure 6 comprising a plurality of reinforcing elements. The inner base structure 6 can be manufactured from different materials. In addition to metal materials, fiber-reinforced composite materials and composites thereof are also possible, for example so-called “fiber metal laminates”.

Adjoining the inner base structure 6 is a first insulating layer 8, which functions in this case as a thermal and electrical insulating layer. It is realized as a dielectric layer. The first insulating layer 8 can include or consist of a glass-fiber reinforced plastics material, for example. This could comprise both a duromer matrix material and a thermoplastic matrix material. The layer thickness of the first insulating layer 8 should be dimensioned such that the base structure 6 is not subject to excessive heat input.

Externally adjoining this is the functional layer 10, which includes or consists of a mat of unwoven carbon nanotubes, for example, which are embedded in a matrix material. This mat is a flexible, moldable and porous layer, which can be processed using conventional methods for processing reinforcing fibers or the like.

By way of example, the functional layer 10 comprises a plurality of connection devices 12, which are realized substantially as electrical connection plates, wires, a busbar or the like. It is thereby possible to apply a voltage to the functional layer 10 so that the heating capacity is generated by the resultant current flow.

Of course, many more of these connection devices 12 can be present, which are distributed along the functional layer 10. The functional layer 10 can further also be segmented so that, for example, certain regions can be provided with a higher heating capacity than other regions.

Adjoining the functional layer, by way of example, is a second insulating layer 14, which is primarily realized as an electrical insulating layer. The second insulating layer 14 is preferably provided with a very small thickness so that the heating capacity via the functional layer 10 can be transmitted outwards very effectively. The second insulating layer 14 could be manufactured from a very thin layer of a glass-fiber reinforced plastics material, for instance.

Finally, the structural component 2 is covered by an outer protective layer 16, which could be realized as a varnish, paint, metal foil or the like.

A particular advantage of this construction is that conventional, automated methods and devices can be used for manufacture. In FIG. 2, the component 2 illustrated is manufactured by an automated device 18. By way of example, the device 18 is illustrated with a robot arm 20, which, by way of example, supports an automated placement head 22. This has, for example, a dispensing roller 24 and an idle roller 26.

As a result of a travelling movement in a placement direction d, a web-type material 28 is dispensed by the dispensing roller 24 and placed onto a first insulating layer 8 by the idle roller 26. The procedure illustrated in FIG. 2 can follow similar procedures in which the first insulating layer 8 and/or the inner base structure 6 are produced on a mold (not shown).

It is, in particular, possible to use pre-impregnated webs in which the fiber types and the matrix material can differ as required. The first insulating layer 8 can be realized by a glass-fiber woven fabric, for instance, which is embedded in a non-conductive matrix.

After the placement of all the provided webs, hardening can be carried out in the usual manner. To this end, the mold can be moved into a hardening furnace and heated there according to requirements.

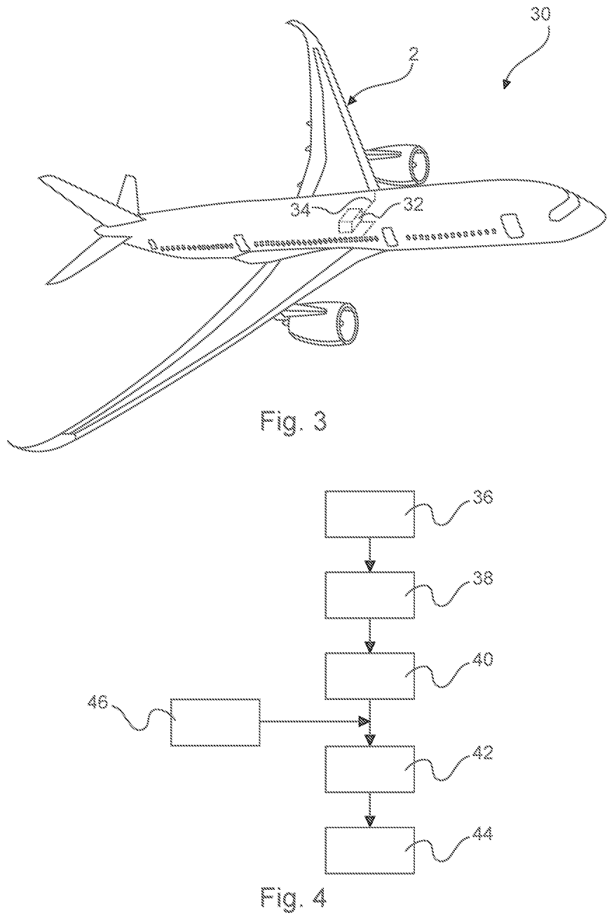

FIG. 3 shows an aircraft 30 which possesses structural components 2, for example, which are realized in the form of wing front edges here. These can then be heated by the functional layer 10, to which an electrical voltage is supplied by an electrical energy source 32 via corresponding lines 34.

Finally, FIG. 4 shows a schematic illustration of a flow chart of the method according to the disclosure. This comprises the steps of providing 36 an inner base structure 6, of applying 38 a first insulating layer 8 to the inner base structure 6, of applying 40 a functional layer 10 in the form of matrix material with carbon allotropes and of applying 42 a protective layer 16. The provision 36 of the inner base structure 6 can include producing a base structure 6 on a mold using reinforcing fibers and a matrix material.

Furthermore, the method can comprise the step of hardening 44 at least the functional layer 10 as a final step or—alternatively—as a step before applying 42 the protective layer 16.

Moreover, the method can further comprise the step of applying 46 a second insulating layer 14 before applying 42 the protective layer 16.

Furthermore, by pre-fabricating a plurality of layers, for instance, it is also possible to also implement a plurality of these method steps simultaneously or to combine them into one step.

In an advantageous embodiment, the method can moreover comprise applying 54 at least one additional structural layer 40, which covers the battery construction 2 at least on one side and stiffens the structural component 38.

In addition, it should be pointed out that “comprising” does not exclude other elements or steps and “a” or “an” does not exclude a multiplicity. Furthermore, it should be pointed out that features which have been described with reference to one of the above exemplary embodiments can also be used in combination with other features of other exemplary embodiments described above. Reference signs in the claims should not be regarded as limiting.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A structural component for an aircraft, comprising:
at least one heatable component portion, the heatable component portion comprising:
a layered construction having an inner base structure;
a first insulating layer arranged outside the inner base structure;
a functional layer of carbon allotropes embedded in a matrix material, the functional layer arranged outside the first insulating layer; and
at least one protective layer arranged outside the functional layer; and
an electrical connection device connected to the functional layer to selectively apply an electrical current to the functional layer to heat the functional layer.

2. The structural component according to claim 1, further comprising a second insulating layer arranged outside the functional layer.

3. The structural component according to claim 1, wherein the inner base structure comprises a composite structure of a matrix material with reinforcing fibers embedded therein.

4. The structural component according to claim 1, wherein the inner base structure comprises a carbon-fiber reinforced plastics material.

5. The structural component according to claim 1, wherein the functional layer comprises carbon nanotubes, which are embedded in the matrix material.

6. The structural component according to claim 1, wherein the first insulating layer comprises a thermal and electrical insulating layer.

7. The structural component according to claim 1, wherein the first insulating layer is a glass-fiber composite material.

8. The structural component according to claim 2, wherein the second insulating layer comprises an electrical insulating layer.

9. The structural component according to claim 2, wherein the second insulating layer comprises aluminum nitride.

10. A method of manufacturing a structural component, the method comprising the steps of:
providing an inner base structure;
applying a first insulating layer to the inner base structure;
applying a functional layer in the form of a matrix material with carbon allotropes; and
applying a protective layer.

11. The method according to claim 10, further comprising the step of hardening at least the functional layer, wherein the hardening is performed as a final step.

12. The method according to claim 10, further comprising the step of hardening at least the functional layer, wherein the hardening is performed before applying the protective layer.

13. The method according to claim 10, further comprising the step of applying a second insulating layer before applying the protective layer.

14. An aircraft comprising:
a structural component according to claim 1; and
an electrical energy source selectively connectable to the electrical connection device of the structural component.

15. The aircraft according to claim 14, wherein the heatable component portion is arranged on a front edge of the structural component.
